(19) United States
(12) Patent Application Publication
(10) Pub. No.: US 2022/0287104 A1
(43) Pub. Date: Sep. 8, 2022

(54) METHOD AND APPARATUS FOR SUPPORT OF MACHINE LEARNING OR ARTIFICIAL INTELLIGENCE TECHNIQUES IN COMMUNICATION SYSTEMS

(71) Applicant: Samsung Electronics Co., Ltd., Suwon-si, Gyeonggi-do (KR)

(72) Inventors: Jeongho Jeon, San Jose, CA (US); Qiaoyang Ye, San Jose, CA (US); Joonyoung Cho, Portland, OR (US)

(21) Appl. No.: 17/653,435

(22) Filed: Mar. 3, 2022

Related U.S. Application Data
(60) Provisional application No. 63/157,466, filed on Mar. 5, 2021.

(51) Int. Cl. H04W 74/08; H04L 25/02

(52) U.S. Cl. CPC H04W 74/0833; H04L 25/0254

(57) ABSTRACT

ML/AI configuration information transmitted from a base station to a UE includes one or more of enabling/disabling an ML approach for one or more operations, one or more ML models to be used for the one or more operations, trained model parameters for the one or more ML models, and whether ML model parameters received from the UE at the base station will be used. Assistance information generated based on the configuration information is transmitted from the UE to the base station. The UE may perform an inference regarding operations based on the configuration information and local data, or the inference may be performed at one of the base station or another network entity based on assistance information received from UEs including the UE. The assistance information may be local data such as UE location, UE trajectory, or estimated DL channel status, inference results, or updated model parameters.

### CROSS-REFERENCE TO RELATED APPLICATION AND CLAIM OF PRIORITY

This application claims priority to U.S. Provisional Patent Application No. 63/157,466 filed Mar. 5, 2021. The content of the above-identified patent document(s) is incorporated herein by reference.

### TECHNICAL FIELD

The present disclosure relates generally to machine learning and/or artificial intelligence in communications equipment, and more specifically to a framework to support ML/AI techniques.

### BACKGROUND

To meet the demand for wireless data traffic having increased since deployment of 4^{th} Generation (4G) or Long Term Evolution (LTE) communication systems and to enable various vertical applications, efforts have been made to develop and deploy an improved 5^{th} Generation (5G) and/or New Radio (NR) or pre-5G/NR communication system. Therefore, the 5G/NR or pre-5G/NR communication system is also called a “beyond 4G network” or a “post LTE system.” The 5G/NR communication system is considered to be implemented in higher frequency (mmWave) bands, e.g., 28 giga-Hertz (GHz) or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and technologies associated therewith is for reference as certain embodiments of the present disclosure may be implemented in 5G systems, 6^{th} Generation (6G) systems, or even later releases which may use terahertz (THz) bands. However, the present disclosure is not limited to any particular class of systems or the frequency bands associated therewith, and embodiments of the present disclosure may be utilized in connection with any frequency band. For example, aspects of the present disclosure may also be applied to deployment of 5G communication systems, 6G communications systems, or communications using THz bands.

### SUMMARY

ML/AI configuration information transmitted from a base station to a UE includes one or more of enabling/disabling an ML approach for one or more operations, one or more ML models to be used for the one or more operations, trained model parameters for the one or more ML models, and whether ML model parameters received from the UE at the base station will be used. Assistance information generated based on the configuration information is transmitted from the UE to the base station. The UE may perform an inference regarding operations based on the configuration information and local data, or the inference may be performed at one of the base station or another network entity based on assistance information received from UEs including the UE. The assistance information may be local data such as UE location, UE trajectory, or estimated DL channel status, inference results, or updated model parameters.

In one embodiment, a UE includes a transceiver configured to receive, from a base station, ML/AI configuration information including one or more of enabling/disabling an ML approach for one or more operations, one or more ML models to be used for the one or more operations, trained model parameters for the one or more ML models, or whether ML model parameters received from the UE at the base station will be used, and transmit, to the base station, assistance information for updating the one or more ML models. The UE includes a processor operatively coupled to the transceiver and configured to generate the assistance information based on the configuration information.

In another embodiment, a method includes receiving, at a UE from a base station, ML/AI configuration information including one or more of enabling/disabling an ML approach for one or more operations, one or more ML models to be used for the one or more operations, trained model parameters for the one or more ML models, or whether ML model parameters received from the UE at the base station will be used. The method includes generating assistance information for updating the one or more ML models based on the configuration information. The method further includes transmitting, from the UE to the base station, the assistance information.

In a third embodiment, a BS includes a processor configured to generate ML/AI configuration information including one or more of enabling/disabling an ML approach for one or more operations, one or more ML models to be used for the one or more operations, trained model parameters for the one or more ML models, or whether ML model parameters received from a user equipment (UE) at the base station will be used. The BS includes a transceiver operatively coupled to the processor and configured to transmit, to one or more UEs including the UE, the configuration information, and receive, from the UE, assistance information for updating the one or more ML models.

In any of the above embodiments, an inference regarding the one or more operations may be performed by the UE based on the configuration information and local data, performed the base station based on assistance information received from a plurality of UEs including the UE, or received from another network entity.

In any of the above embodiments, the base station may perform an inference regarding the one or more operations to generate an inference result, or may receive the inference result from the other network entity, may transmit to the UE control signaling based on the inference result, where the control signaling includes one of a command based on the inference result and updated configuration information.

In any of the above embodiments, the assistance information may include: local data regarding the UE, such as UE location, UE trajectory, or estimated downlink (DL) channel status; inference results regarding the one or more operations; and/or updated model parameters based on local training of the one or more ML models, for updating the one or more ML models. The assistance information may be reported using L1/L2 including UCI, MAC-CE, or any higher layer signaling via a PUCCH, a PUSCH, or a PRACH. Reporting of the assistance information may be triggered periodically, aperiodically, or semi-persistently.

In any of the above embodiments, the configuration information may specify a federated learning ML model to be used for the one or more operations, where the federated learning ML model involves model training at the UE based on local data available at UE and reporting of updated model parameters according to the configuration information.

In any of the above embodiments, the UE may be configured to transmit, to the base station, UE capability information for use by the base station in generating the configuration information, where the UE capability information includes support by the UE for the ML approach for the one or more operations, and/or support by the UE for model training at the UE based on local data available at UE.

In any of the above embodiments, the configuration information may include N indices each corresponding to a different one of the one or more operations and indicating enabling or disabling of the ML approach for the corresponding operation, M indices each corresponding to a different one of M predefined ML algorithms and indicating an ML algorithm to be employed for the corresponding operation(s), and/or K indices each corresponding to a different one of K predefined ML operation modes and indicating an ML operation mode to be employed, where each of the ML operation modes includes one or more operations, an ML algorithm to be employed for a corresponding one of the one or more operations, and ML model parameters for the ML algorithm to be employed for the corresponding one of the one or more operations.

In any of the above embodiments, the ML algorithm may comprise supervised learning and the ML model parameters comprise features, weights, and regularization. The ML algorithm may comprise reinforcement learning and the ML model parameters comprise a set of states, a set of actions, a state transition probability, or a reward function. The ML algorithm may comprise a deep neural network and the ML model parameters comprise a number of layers, a number of neurons in each layer, weights and bias for each neuron, an activation function, inputs, or outputs. The ML algorithm may comprise federated learning and the ML model parameters comprise whether the UE is configured for local training and/or reporting, a number of iterations for local training before polling, and local batch size.

In any of the above embodiments, the configuration information may be signaled by a portion of a broadcast by the base station including cell-specific information, a system information block (SIB), UE-specific signaling, or UE group-specific signaling.

In any of the above embodiments, the UE may be configured to perform an inference regarding the one or more operations based on the configuration information and local data, or the inference regarding the one or more operations may be performed at one of the base station or another network entity, based on assistance information received from a plurality of UEs including the UE.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an exemplary networked system utilizing artificial intelligence and/or machine learning according to various embodiments of this disclosure;

FIG. 2 illustrates an exemplary base station (BS) utilizing artificial intelligence and/or machine learning according to various embodiments of this disclosure;

FIG. 3 illustrates an exemplary electronic device for communicating in the networked computing system utilizing artificial intelligence and/or machine learning according to various embodiments of this disclosure;

FIG. 4 shows an example flowchart illustrating an example of BS operation to support ML/AI techniques according to embodiments of the present disclosure;

FIG. 5 shows an example flowchart illustrating an example of UE operation to support ML/AI techniques, where the UE performs the inference operation, according to embodiments of the present disclosure;

FIG. 6 shows an example flowchart illustrating an example of BS operation to support ML/AI techniques, where BS performs the inference operation according to embodiments of the present disclosure;

FIG. 7 shows an example flowchart illustrating an example of UE operation to support ML/AI techniques according to embodiments of the present disclosure;

FIG. 8 shows an example flowchart illustrating an example of BS operation in UE capability negotiation for support of ML/AI techniques according to embodiments of the present disclosure; and

FIG. 9 shows an example flowchart illustrating an example of UE operation in UE capability negotiation for support of ML/AI techniques according to embodiments of the present disclosure.

### DETAILED DESCRIPTION

The figures included herein, and the various embodiments used to describe the principles of the present disclosure are by way of illustration only and should not be construed in any way to limit the scope of the disclosure. Further, those skilled in the art will understand that the principles of the present disclosure may be implemented in any suitably arranged wireless communication system.

### Abbreviations:

ML Machine Learning

AI Artificial Intelligence

gNB Base Station

UE User Equipment

NR New Radio

3GPP 3rd Generation Partnership Project

SIB System Information Block

DCI Downlink Control Information

PDCCH Physical Downlink Control Channel

PDSCH Physical Downlink Shared Channel

PUSCH Physical Uplink Shared Channel

RRC Radio Resource Control

DL Downlink

UL Uplink

LTE Long-Term Evolution

BWP Bandwidth Part

Recent advances in machine learning (ML) or artificial intelligence (AI) have brought new opportunities in various application areas. Wireless communication is one of these areas starting to leverage ML/AI techniques to solve complex problems and improve system performance. The present disclosure relates generally to wireless communication systems and, more specifically, to supporting ML/AI techniques to wireless communication systems. The overall framework to support ML/AI techniques in wireless communication systems and corresponding signaling details are discussed in this disclosure.

The present disclosure relates to the support of ML/AI techniques in a communication system. Techniques, apparatuses and methods are disclosed for configuration of ML/AI approaches, specifically the detailed configuration method for various ML/AI algorithms and corresponding model parameters, UE capability negotiation for ML/AI operations, and signaling method for the support of training and inference operations at different components in the system.

Aspects, features, and advantages of the disclosure are readily apparent from the following detailed description, simply by illustrating a number of particular embodiments and implementations. The subject matter of the disclosure is also capable of other and different embodiments, and several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

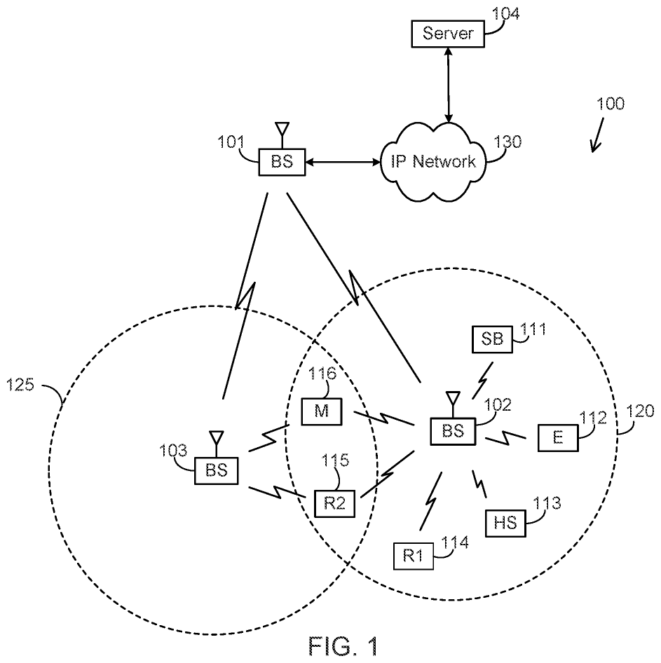

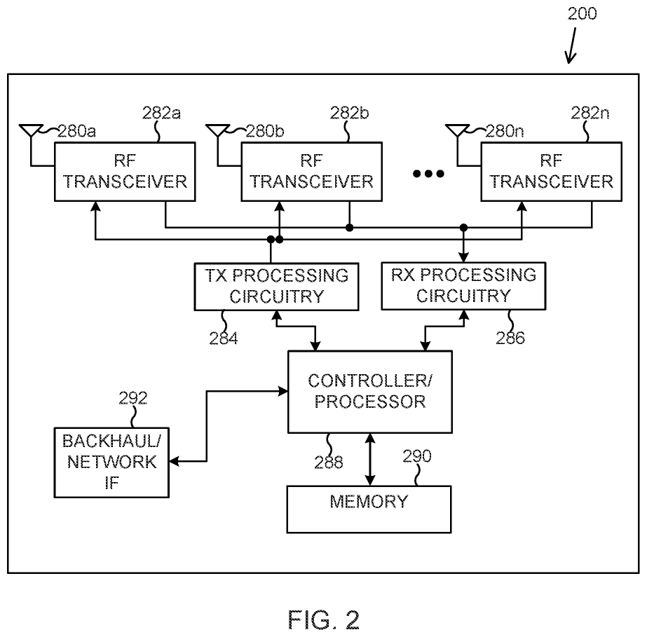

Throughout this disclosure, all figures such as FIG. 1, FIG. 2, and so on, illustrate examples according to embodiments of the present disclosure. For each figure, the corresponding embodiment shown in the figure is for illustration only. One or more of the components illustrated in each figure can be implemented in specialized circuitry configured to perform the noted functions or one or more of the components can be implemented by one or more processors executing instructions to perform the noted functions. Other embodiments could be used without departing from the scope of the present disclosure. In addition, the descriptions of the figures are not meant to imply physical or architectural limitations to the manner in which different embodiments may be implemented. Different embodiments of the present disclosure may be implemented in any suitably-arranged communications system.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

FIG. 1 illustrates an exemplary networked system utilizing artificial intelligence and/or machine learning according to various embodiments of this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a base station (BS) 101, a BS 102, and a BS 103. The BS 101 communicates with the BS 102 and the BS 103. The BS 101 also communicates with at least one Internet protocol (IP) network 130, such as the Internet, a proprietary IP network, or another data network.

The BS 102 provides wireless broadband access to the network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R1); a UE 115, which may be located in a second residence (R2); and a UE 116, which may be a mobile device (M) like a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G, LTE, LTE Advanced (LTE-A), WiMAX, WiFi, NR, or other wireless communication techniques.

Depending on the network type, other well-known terms may be used instead of “base station” or “BS,” such as node B, evolved node B (“eNodeB” or “eNB”), a 5G node B (“gNodeB” or “gNB”) or “access point.” For the sake of convenience, the term “base station” and/or “BS” are used in this disclosure to refer to network infrastructure components that provide wireless access to remote terminals. Also, depending on the network type, other well-known terms may be used instead of “user equipment” or “UE,” such as “mobile station” (or “MS”), “subscriber station” (or “SS”), “remote terminal,” “wireless terminal,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extent of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

Although FIG. 1 illustrates one example of a wireless network 100, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BS 101, 102, and/or 103 could provide access to other or additional external networks, such as external telephone networks or other types of data networks.

FIG. 2 illustrates an exemplary base station (BS) utilizing artificial intelligence and/or machine learning according to various embodiments of this disclosure. The embodiment of the BS 200 illustrated in FIG. 2 is for illustration only, and the BSs 101, 102 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 200 includes multiple antennas 280a-280n, multiple radio frequency (RF) transceivers 282a-282n, transmit (TX or Tx) processing circuitry 284, and receive (RX or Rx) processing circuitry 286. The BS 200 also includes a controller/processor 288, a memory 290, and a backhaul or network interface 292.

The RF transceivers 282a-282n receive, from the antennas 280a-280n, incoming RF signals, such as signals transmitted by UEs in the network 100. The RF transceivers 282a-282n down-convert the incoming RF signals to generate IF or baseband signals. The IF or baseband signals are sent to the RX processing circuitry 286, which generates processed baseband signals by filtering, decoding, and/or digitizing the baseband or IF signals. The RX processing circuitry 286 transmits the processed baseband signals to the controller/processor 288 for further processing.

The TX processing circuitry 284 receives analog or digital data (such as voice data, web data, e-mail, or interactive video game data) from the controller/processor 288. The TX processing circuitry 284 encodes, multiplexes, and/or digitizes the outgoing baseband data to generate processed baseband or IF signals. The RF transceivers 282a-282n receive the outgoing processed baseband or IF signals from the TX processing circuitry 284 and up-converts the baseband or IF signals to RF signals that are transmitted via the antennas 280a-280n.

The controller/processor 288 can include one or more processors or other processing devices that control the overall operation of the BS 200. For example, the controller/processor 288 could control the reception of forward channel signals and the transmission of reverse channel signals by the RF transceivers 282a-282n, the RX processing circuitry 286, and the TX processing circuitry 284 in accordance with well-known principles. The controller/processor 288 could support additional functions as well, such as more advanced wireless communication functions and/or processes described in further detail below. For instance, the controller/processor 288 could support beam forming or directional routing operations in which outgoing signals from multiple antennas 280a-280n are weighted differently to effectively steer the outgoing signals in a desired direction. Any of a wide variety of other functions could be supported in the BS 200 by the controller/processor 288. In some embodiments, the controller/processor 288 includes at least one microprocessor or microcontroller.

The controller/processor 288 is also capable of executing programs and other processes resident in the memory 290, such as a basic operating system (OS). The controller/processor 288 can move data into or out of the memory 290 as required by an executing process.

The controller/processor 288 is also coupled to the backhaul or network interface 292. The backhaul or network interface 292 allows the BS 200 to communicate with other devices or systems over a backhaul connection or over a network. The interface 292 could support communications over any suitable wired or wireless connection(s). For example, when the BS 200 is implemented as part of a cellular communication system (such as one supporting 6G, 5G, LTE, or LTE-A), the interface 292 could allow the BS 200 to communicate with other BSs over a wired or wireless backhaul connection. When the BS 200 is implemented as an access point, the interface 292 could allow the BS 200 to communicate over a wired or wireless local area network or over a wired or wireless connection to a larger network (such as the Internet). The interface 292 includes any suitable structure supporting communications over a wired or wireless connection, such as an Ethernet or RF transceiver.

The memory 290 is coupled to the controller/processor 288. Part of the memory 290 could include a RAM, and another part of the memory 290 could include a Flash memory or other ROM.

As described in more detail below, base stations in a networked computing system can be assigned as synchronization source BS or a slave BS based on interference relationships with other neighboring BSs. In some embodiments, the assignment can be provided by a shared spectrum manager. In other embodiments, the assignment can be agreed upon by the BSs in the networked computing system. Synchronization source BSs transmit OSS to slave BSs for establishing transmission timing of the slave BSs.

Although FIG. 2 illustrates one example of BS 200, various changes may be made to FIG. 2. For example, the BS 200 could include any number of each component shown in FIG. 2. As a particular example, an access point could include a number of interfaces 292, and the controller/processor 288 could support routing functions to route data between different network addresses. As another particular example, while shown as including a single instance of TX processing circuitry 284 and a single instance of RX processing circuitry 286, the BS 200 could include multiple instances of each (such as one per RF transceiver). Also, various components in FIG. 2 could be combined, further subdivided, or omitted and additional components could be added according to particular needs.

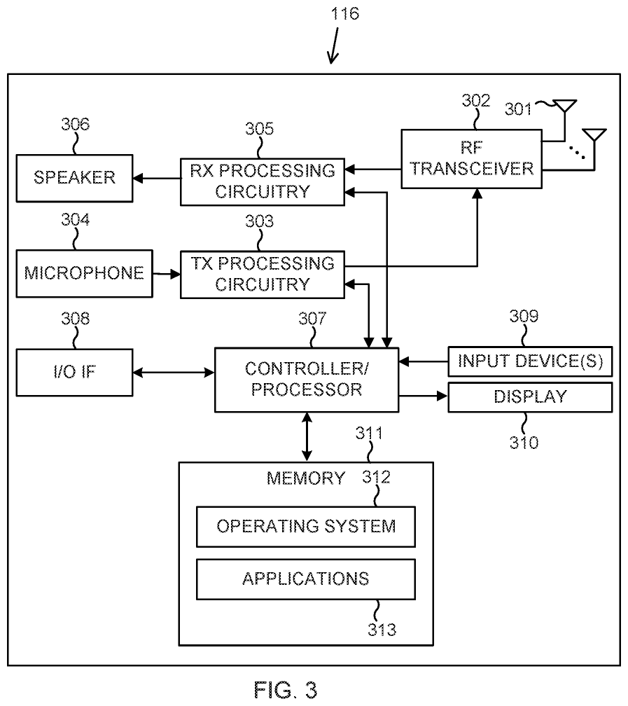

FIG. 3 illustrates an exemplary electronic device for communicating in the networked computing system utilizing artificial intelligence and/or machine learning according to various embodiments of this disclosure. The embodiment of the UE 116 illustrated in FIG. 3 is for illustration only, and the UEs 111-115 and 117-119 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes an antenna 301, a radio frequency (RF) transceiver 302, TX processing circuitry 303, a microphone 304, and receive (RX) processing circuitry 305. The UE 116 also includes a speaker 306, a controller or processor 307, an input/output (I/O) interface (IF) 308, a touchscreen display 310, and a memory 311. The memory 311 includes an OS 312 and one or more applications 313.

The RF transceiver 302 receives, from the antenna 301, an incoming RF signal transmitted by an gNB of the network 100. The RF transceiver 302 down-converts the incoming RF signal to generate an IF or baseband signal. The IF or baseband signal is sent to the RX processing circuitry 305, which generates a processed baseband signal by filtering, decoding, and/or digitizing the baseband or IF signal. The RX processing circuitry 305 transmits the processed baseband signal to the speaker 306 (such as for voice data) or to the processor 307 for further processing (such as for web browsing data).

The TX processing circuitry 303 receives analog or digital voice data from the microphone 304 or other outgoing baseband data (such as web data, e-mail, or interactive video game data) from the processor 307. The TX processing circuitry 303 encodes, multiplexes, and/or digitizes the outgoing baseband data to generate a processed baseband or IF signal. The RF transceiver 302 receives the outgoing processed baseband or IF signal from the TX processing circuitry 303 and up-converts the baseband or IF signal to an RF signal that is transmitted via the antenna 301.

The processor 307 can include one or more processors or other processing devices and execute the OS 312 stored in the memory 311 in order to control the overall operation of the UE 116. For example, the processor 307 could control the reception of forward channel signals and the transmission of reverse channel signals by the RF transceiver 302, the RX processing circuitry 305, and the TX processing circuitry 303 in accordance with well-known principles. In some embodiments, the processor 307 includes at least one microprocessor or microcontroller.

The processor 307 is also capable of executing other processes and programs resident in the memory 311, such as processes for CSI reporting on uplink channel. The processor 307 can move data into or out of the memory 311 as required by an executing process. In some embodiments, the processor 307 is configured to execute the applications 313 based on the OS 312 or in response to signals received from gNBs or an operator. The processor 307 is also coupled to the I/O interface 309, which provides the UE 116 with the ability to connect to other devices, such as laptop computers and handheld computers. The I/O interface 309 is the communication path between these accessories and the processor 307.

The processor 307 is also coupled to the touchscreen display 310. The user of the UE 116 can use the touchscreen display 310 to enter data into the UE 116. The touchscreen display 310 may be a liquid crystal display, light emitting diode display, or other display capable of rendering text and/or at least limited graphics, such as from web sites.

The memory 311 is coupled to the processor 307. Part of the memory 311 could include RAM, and another part of the memory 311 could include a Flash memory or other ROM.

Although FIG. 3 illustrates one example of UE 116, various changes may be made to FIG. 3. For example, various components in FIG. 3 could be combined, further subdivided, or omitted and additional components could be added according to particular needs. As a particular example, the processor 307 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

In one embodiment, the framework to support ML/AI techniques can include the model training performed at BS or a network entity or outside of the network (e.g., via offline training), and inference operation performed at UE side. The framework supports, for example, UE capability information and configuration enabling/disabling the ML approach, etc. as described in further detail below. The ML model may need to be retrained from time to time, and may use assistance information for such retraining.

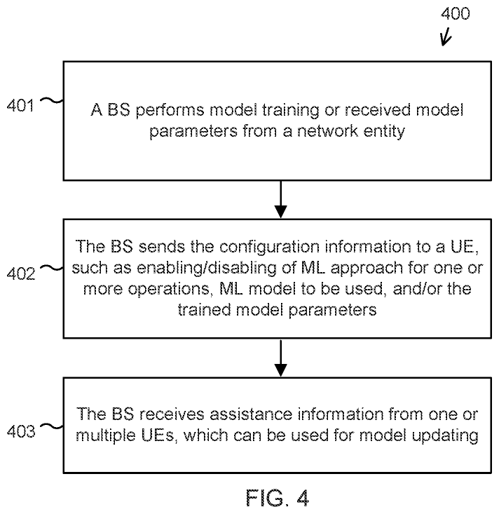

FIG. 4 shows an example flowchart illustrating an example of BS operation to support ML/AI techniques according to embodiments of the present disclosure.

FIG. 4 is an example of a method 400 for operations at BS side to support ML/AI techniques. At operation 401, a BS performs model training, or receives model parameters from a network entity. In one embodiment, the model training can be performed at BS side. Alternatively, the model training can be performed at another network entity (e.g., RAN Intelligent Controller as defined in Open Radio Access Network (O-RAN)), and trained model parameters can be sent to the BS. In yet another embodiment, the model training can be performed offline (e.g., model training is performed outside of the network), and the trained model parameters can be sent to the BS or a network entity. At operation 402, the BS sends the configuration information to UE, which can include ML/AI related configuration information such as enabling/disabling of ML approach for one or more operations, ML model to be used, and/or the trained model parameters. Part of or all the configuration information can be broadcasted as a part of cell-specific information, for example by system information such as MIB, SIB1 or other SIBS. Alternatively, part of or all the configuration information can be sent as UE-specific signaling, or group-specific signaling. More details about the signaling method are discussed in the following “Configuration method” section. At operation 403, the BS receives assistance information from one or multiple UEs. The assistance information can include information to be used for model updating, as is subsequently described.

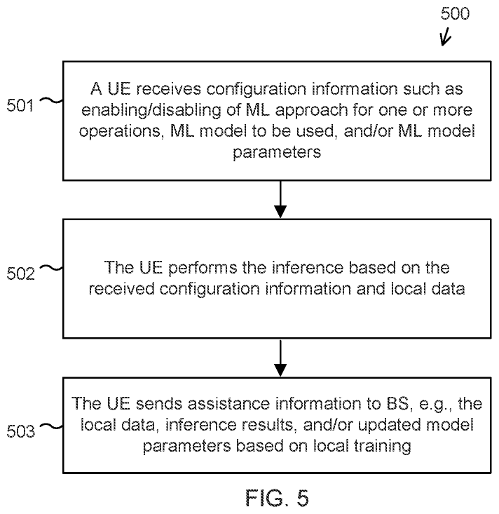

FIG. 5 shows an example flowchart illustrating an example of UE operation to support ML/AI techniques, where the UE performs the inference operation, according to embodiments of the present disclosure.

FIG. 5 illustrates an example of a method 500 for operations at the UE side to support ML/AI techniques. At operation 501, a UE receives configuration information, including information related to ML/AI techniques such as enabling/disabling of ML approach for one or more operations, ML model to be used, and/or the trained model parameters. Part of or all the configuration information can be broadcasted as a part of cell-specific information, for example by system information such as MIB, SIB1 or other SIBS. Alternatively, part of or all the configuration information can be sent as UE-specific signaling, or group-specific signaling. More details about the signaling method are discussed in the following “Configuration method” section. At operation 502, the UE performs the inference based on the received configuration information and local data. For example, the UE follows the configured ML model and model parameters, and uses local data and/or data sent from the BS to perform the inference operation. At operation 503, the UE sends assistance information to BS. The assistance information can include information such as local data at UE, inference results, and/or updated model parameters based on local training, etc., which can be used for model updating, as is subsequently described in the “UE assistance information” section. In one example, federated learning approach can be predefined or configured, where UE may perform the model training based on local data available at UE and report the updated model parameters, according to the configuration (e.g., whether updated model parameters sent from the UE will be used or not). In another example, centralized learning approach can be predefined or configured, where UE will not perform local training. Instead, the model training and/or update of model parameters are performed at BS, or a network entity or offline (e.g., outside of the network).

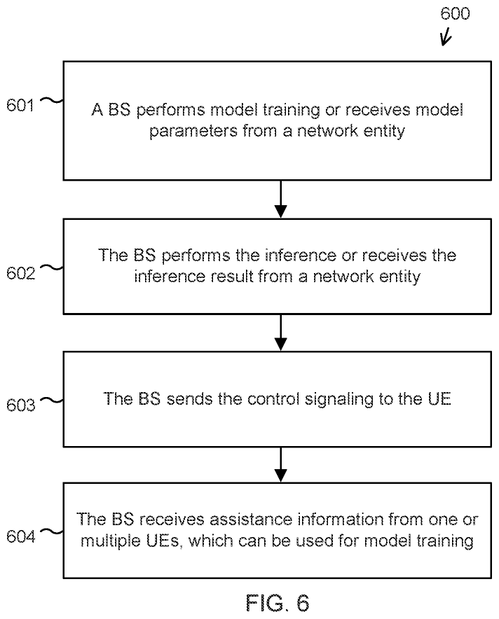

FIG. 6 shows an example flowchart illustrating an example of BS operation to support ML/AI techniques, where BS performs the inference operation according to embodiments of the present disclosure. In some embodiments, the UE may have limited capability (e.g., be a “dummy” device).

FIG. 6 is an example of a method 600 for operations at BS side to support ML/AI techniques, where BS performs the inference operation. At operation 601, a BS performs model training, or receives model parameters from a network entity. In one embodiment, the model training can be performed at BS side. Alternatively, the model training can be performed at another network entity, and trained model parameters can be sent to the BS. In yet another embodiment, the model training can be performed offline (e.g., model training is performed outside of the network), and the trained model parameters can be sent to the BS or a network entity. At operation 602, the BS performs the inference or receives the inference result from a network entity. At operation 603, the BS sends control signaling to the UE. In one example, the control signaling can include command determined based on the inference result. Taking the handover operation as an example, ML based handover operation can be supported, where the BS or a network entity performs the model training or receives the trained model parameters, based on which BS or a network entity can perform the inference operation and obtain the results related to handover operation, e.g., whether handover should be performed for a certain UE and/or which cell to handover to if handover is to be performed. Based on the inference result, the BS can send a handover command to the corresponding UE, regarding whether and/or how to perform the handover operation. At operation 604, the BS receives assistance information from one or multiple UEs. The assistance information can include information to be used for model updating, as is subsequently described.

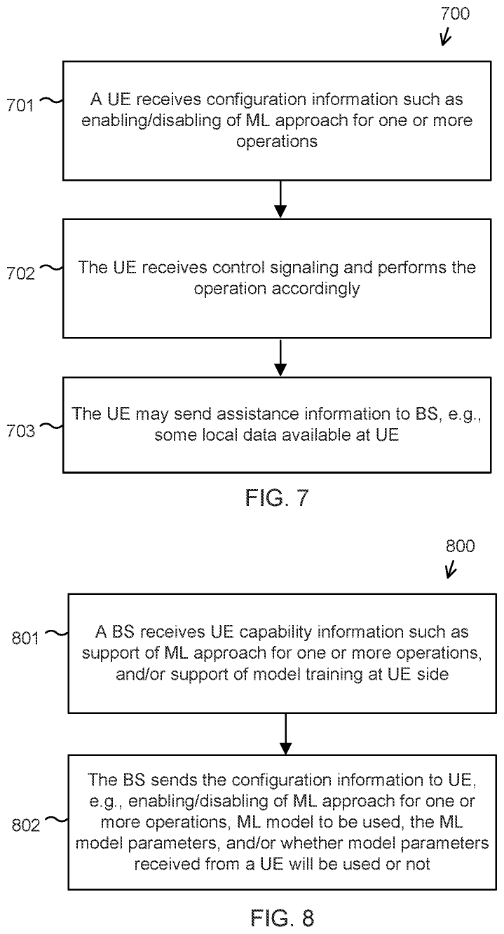

FIG. 7 shows an example flowchart illustrating an example of UE operation to support ML/AI techniques according to embodiments of the present disclosure.

FIG. 7 is an example of a method 700 for operations at UE side to support ML/AI techniques. At operation 701, a UE receives configuration information, including information related to ML/AI techniques such as enabling/disabling of ML approach for one or more operations, as is subsequently described in the “Configuration method” section. At operation 702, the UE receives control signaling from BS, and performs the operation accordingly. In one example, the control signaling can include command determined based on the inference result. Taking the handover operation as an example, the UE may receive the handover indication from BS such as whether handover should be performed and/or which cell to handover to if handover is to be performed, and perform the handover operation following the indication. At operation 703, the UE may send assistance information to the BS. The assistance information can include information to be used for model updating or inference operation, as is subsequently described. Similar to the framework described in connection FIG. 5, in one example, federated learning approach can be predefined or configured, where the UE may perform the model training based on local data available at UE and report the updated model parameters, according to the configuration (e.g., whether updated model parameters sent from the UE will be used or not). In another example, centralized learning approach can be predefined or configured, where UE will not perform local training. Instead, the model training and/or update of model parameters are performed at BS, or a network entity or offline (e.g., outside of the network).

Methods for UE capability negotiation regarding support of ML/AI techniques are disclosed. For example, a BS may send an inquiry regarding UE capability.

FIG. 8 shows an example flowchart illustrating an example of BS operation in UE capability negotiation for support of ML/AI techniques according to embodiments of the present disclosure.

FIG. 8 is an example of a method 800 for operations at the BS side in UE capability negotiation for support of ML/AI techniques. At operation 801, a BS receives the UE capability information, e.g., the support of ML approach for one or more operations, and/or support of model training at the UE side, as is subsequently described below. At operation 802, the BS sends the configuration information to the UE, which can include ML/AI related configuration information such as enabling/disabling of ML approach for one or more operations, ML model to be used, the trained model parameters, and/or whether the model parameters received from a UE will be used or not, etc. Part of or all the configuration information can be broadcasted as a part of cell-specific information, for example by system information such as MIB, SIB1 or other SIBS. Alternatively, part of or all the configuration information can be sent as UE-specific signaling, or group-specific signaling. More details about the signaling method are discussed below.

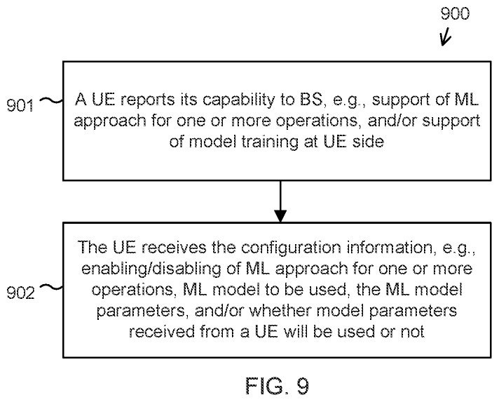

FIG. 9 shows an example flowchart illustrating an example of UE operation in UE capability negotiation for support of ML/AI techniques according to embodiments of the present disclosure. Depending on the UE capability, the BS can request different levels of support for ML from the UE.

FIG. 9 is an example of a method 900 for operations at the UE side in UE capability negotiation for support of ML/AI techniques. At operation 901, a UE reports its capability to the BS, e.g., the support of ML approach for one or more operations, and/or support of model training at the UE side, as is subsequently described. At operation 902, the UE receives the configuration information, which can include ML/AI related configuration information such as enabling/disabling of ML approach for one or more operations, ML model to be used, the trained model parameters, and/or whether the model parameters received from a UE will be used or not, etc. Part of or all the configuration information can be broadcasted as a part of cell-specific information, for example by system information such as MIB, 81131 or other SIBs. Alternatively, part of or all the configuration information can be sent as UE-specific signaling, or group-specific signaling. More details about the signaling method are discussed below.

The configuration information related to ML/AI techniques (e.g., at operations 402, 501, 701, 802 or 902) can include one or multiple of the following information.

In one embodiment, the configuration information can include whether ML/AI techniques for certain operation/use case is enabled or disabled. One or multiple operations/use cases can be predefined. For example, there can be N predefined operations, with index 1, 2, . . . , N corresponding to one operation such as “UL channel prediction”, “DL channel estimation”, “handover”, etc., respectively. The configuration can indicate the indexes of the operations which are enabled, or there can be a Boolean parameter to enable or disable the ML/AI approach for each operation.

In one embodiment, the configuration information can include which ML/AI model or algorithm to be used for certain operation/use case. For example, there can be M predefined ML algorithms, with index 1, 2, . . . , M corresponding to one ML algorithm such as linear regression, quadratic regression, reinforcement learning algorithms, deep neutral network, etc. In one example, the federated learning can be defined as one of the ML algorithm. Alternatively, there can be another parameter to define whether the approach is based on federated learning or not.

In another embodiment, the use case and ML/AI approach can be jointly configured. For example, there can be K predefined operation modes, where each mode corresponding to certain operation/use case with certain ML algorithm. One or more modes can be configured. TABLE 1 provides an example of this embodiment, where the configuration information can include one or multiple mode indexes to enable the operations/use cases and ML algorithms. One or more columns in TABLE 1 can be optional in different embodiments. For example, the configuration for Al/ML approach for cell selection/reselection can be separate from the table, and indicated in different signaling method, e.g., broadcasted in system information (e.g., MIB, SIB1 or other SIBs), while the configuration information for Al/ML approach for other operations can be indicated via UE-specific or group-specific signaling. The use case can be separately configured, the model can be separately configured, or the pair of use case and model can be configured together.

TABLE 1
Example of ML/AI operation modes, where different
operations/use cases, ML algorithms and/or corresponding
key model parameters can be predefined

| | Operation/ | | |
|---|---|---|---|
| Mode | use case | ML algorithms | Model parameters |
| 1 | DL channel | Regression | Features, weights, and/or |
| | estimation | | regularization, etc. |
| 2 | DL channel | Reinforcement | States, actions, transition |
| | estimation | learning | probability, and/or reward |
| | | | function, etc. |
| 3 | UL channel | Reinforcement | States, actions, transition |
| | prediction | learning | probability, and/or reward |
| | | | function, etc. |
| 4 | Handover | Reinforcement | States, actions, transition |
| | | learning | probability, and/or reward |
| | | | function, etc. |
| 5 | Handover | Deep neutral | Layers, number of neutrons each |
| | | network | layer, weights and bias for |
| | | | connection between neutrons in |
| | | | different layers, activation |
| | | | function, inputs, and/or outputs, |
| | | | etc. |
| 6 | Handover | Federated | ML model such as loss function, |
| | | learning | initial parameters for the model, |
| | | | whether UE is configured for the |
| | | | training and reporting, local |
| | | | batch size for each learning |
| | | | iteration, and/or learning rate, |
| | | | etc. |
| . . . | | | |
| K | Cell | Deep neutral | Layers, number of neutrons each |
| | reselection | network | layer, weights and bias for |
| | | | connection between neutrons in |
| | | | different layers, activation |
| | | | function, inputs, and/or outputs, |
| | | | etc. |

The configuration information can include the model parameters of ML algorithms. In one embodiment, one or more of the following ML algorithms can be defined, and one or more of the model parameters listed below for the ML algorithms can be predefined or configured as part of the configuration information.

Supervised learning algorithms, such as linear regression, quadratic regression, etc.

The model parameters for this type of algorithms can include features such as number of features and what the features are, weights for the regression, regularization such as L1 or L2 regularization and/or regularization parameters.

For example, the following regression model can be used, where

$$y ( x , w ) = {w}_{0} + {\sum }_{i}^{M - 1} {w}_{i} {∅}_{i} ( x ) ,$$

and the objective is

$${min}_{w} \frac{1}{2} {\sum }_{j}^{N} {‖ {y}^{( j )} - y ( {x}^{( j )} , w ) ‖}^{2} + \frac{λ}{2} {‖ w ‖}^{2} ,$$

with N being the number of training samples, M being the number of features, w being the weights, x^{(j)} and y^{(j)} being the jth training sample, ∅ᵢ(x) being the basis function (e.g., ∅ᵢ(x)=xᵢ for linear regression), λ being the regularization parameter and

$$\frac{λ}{2} {‖ w ‖}^{2}$$

being the L2 regularization term.

The model parameters for reinforcement learning algorithms can include set of states, set of actions, state transition probability, and/or reward function.

For example, the set of states can include UE location, satellite location, UE trajectory, and/or satellite trajectory for DL channel estimation, or include UE location, satellite location, UE trajectory, satellite trajectory, and/or estimated DL channel for UL channel prediction, or include location, satellite location, UE trajectory, satellite trajectory, estimated DL channel, measured signal to interference plus noise ratio (SINK), reference signal received power (RSRP) and/or reference signal received quality (RSRQ), current connected cell, and/or cell deployment for handover operation, etc.

As another example, the set of actions can include possible set of DL channel status for DL channel estimation, or include possible set of UL channel status, MCS indexes, and/or UL transmission power for UL channel prediction, or include set of cells to be connected to for handover operation, etc.

In yet another example, the state transition probability may not be available, and thus may not be included in as part of the model parameters. In this case, other learning algorithms such as Q-learning can be used.

The model parameters for deep neural networks can include the number of layers, the number of neutrons in each layer, the weights and bias for each neutron in previous layer to each neutron in the next layer, activation function, inputs such as input dimension and/or what the inputs are, outputs such as output dimension and/or what the outputs are, etc.

The model parameters for federated learning algorithms can include the ML model to be used such as the loss function, the initial parameters for the ML model, whether the UE is configured for the local training and/or reporting, the number of iterations for local training before polling, local batch size for each learning iteration, and/or learning rate, etc.

In one embodiment, part of or all the configuration information can be broadcasted as a part of cell-specific information, for example by system information such as MIB, SIB1 or other SIBs. Alternatively, a new SIB can be introduced for the indication of configuration information. For example, the enabling/disabling of ML approach, ML model and/or model parameters for certain operation/use case can be broadcasted, such as the enabling/disabling of ML approach, which ML model to be used and/or model parameters for cell reselection operation can be broadcasted. TABLE 2 provides an example (new parameter indicated in boldface) of sending the configuration information via SIB1, where K operation modes are predefined and one mode can be configured. In other examples, multiple modes can be configured. In another example, the updates of model parameters can be broadcasted. In yet another example, the configuration information of neighboring cells, e.g., the enabling/disabling of ML approach, ML model and/or model parameters for certain operation/use case of neighboring cells, can be indicated as part of the system information, e.g., in MIB, SIB1, SIB3, SIB4 or other SIBs.

TABLE 2
Example of information element (IE) SIB1 modification
for configuration of ML/AI techniques

| SIB1 ::= SEQUENCE { | | |
|---|---|---|
| cellSelectionInfo | SEQUENCE { | |
| q-RxLevMin | Q-RxLevMin, | |
| q-RxLevMinOffset | INTEGER | (1..8) |
| OPTIONAL, -- Need S | | |
| q-RxLevMinSUL | Q-RxLevMin | |
| OPTIONAL, -- Need R | | |
| q-QualMin | Q-QualMin | |
| OPTIONAL, -- Need S | | |
| q-QualMinOffset | INTEGER | (1..8) |

| OPTIONAL -- Need S | |
|---|---|
| } | |
| OPTIONAL, -- Cond Standalone | |
| ... | |
| ml-Operationmode | INTEGER (1..K) |
| ... | |
| nonCriticalExtension | SEQUENCE{ } |

OPTIONAL
}

In TABLE 2, ml-Operationmode indicates a combination of enabling of ML approach for a certain operation and the enabled ML model.

In another embodiment, part of or all the configuration information can be sent by UE-specific signaling. The configuration information can be common among all configured DL/UL BWPs or can be BWP-specific. For example, the UE-specific RRC signaling, such as an IE PDSCH-ServingCellConfig or an IE PDSCH-Config in IE BWP-DownlinkDedicated, can include configuration of enabling/disabling ML approach for DL channel estimation, which ML model to be used and/or model parameters for DL channel estimation. As another example, the UE-specific RRC signaling, such as an IE PUSCH-ServingCellConfig or an IE PUSCH-Config in IE BWP-UplinkDedicated, can include configuration of enabling/disabling ML approach for UL channel prediction, which ML model to be used and/or model parameters for UL channel prediction.

TABLE 3 provides an example of configuration for DL channel estimation via IE PDSCH-ServingCellConfig. In this example, the ML approach for DL channel estimation is enabled or disabled via a BOOLEAN parameter, and the ML model/algorithm to be used is indicated via index from 1 to M. In some examples, the combination of ML model and parameters to be used for the model can be predefined, with each index from 1 to M corresponding to a certain ML model and a set of model parameters. Alternatively, one or multiple ML model/algorithms can be defined for each operation/use case, and a set of parameters in the IE can indicate the values for model parameters correspondingly.

TABLE 3
Example of IE PDSCH-ServingCellConfig modification
for configuration of ML/AI techniques

| | |
|---|---|
| PDSCH-ServingCellConfig ::= | SEQUENCE { |
| codeBlockGroupTransmission | SetupRelease { PDSCH- |

```
        CodeBlockGroupTransmission } OPTIONAL, -- Need
        M
```

| | |
|---|---|
| xOverhead | ENUMERATED { xOh6, xOh12, |
| xOh18 } | OPTIONAL, -- Need S |

```
  ...,
  [[
```

| | | |
|---|---|---|
| maxMIMO-Layers | INTEGER | (1..8) |

OPTIONAL, -- Need M

| | |
|---|---|
| processingType2Enabled | BOOLEAN |

```
        OPTIONAL -- Need M
      ]],
      [[
  pdsch-CodeBlockGroupTransmissionList-r16 SetupRelease { PDSCH-
        CodeBlockGroupTransmissionList-r16 } OPTIONAL --
        Need M
  ]]
```

| | |
|---|---|
| processingType2Enabled | BOOLEAN |

OPTIONAL -- Need M

| | |
|---|---|
| pdsch-MlChEst | SEQUENCE { |
| mlEnabled | BOOLEAN |
| mlAlgo | INTEGER (1...M) |

...
}
}

In yet another embodiment, part of or all the configuration information can be sent by group-specific signaling. A UE group-specific RNTI can be configured, e.g., using value 0001-FFEF or the reserved value FFF0-FFFD. The group-specific RNTI can be configured via UE-specific RRC signaling.

The UE assistance information related to ML/AI techniques (e.g., at operations 403, 503, 604, 703 or 902) can include one or multiple of the following information.

Information available at the UE side, such as UE location, UE trajectory, estimated DL channel status, etc. The information can be used for inference operation, e.g., when inference is performed at the BS or a network entity. Alternatively, the information can include UE inference result if inference is performed at the UE side.

For example, the updates of model parameters based on local training at the UE side can be reported to the BS, which can be used for model updates, e.g., in federated learning approaches. The report of the updated model parameters can depend on the configuration. For example, if the configuration is that the model parameter updates from the UE would not be used, the UE may not report the model parameter updates. On the other hand, if the configuration is that the model parameter updates from the UE may be used for model updating, the UE may report the model parameter updates.

The report of the assistance information can be via PUCCH and/or PUSCH. A new UCI type, a new PUCCH format and/or a new medium access control-control element (MAC-CE) can be defined for the assistance information report.

Regarding the triggering method, in one embodiment, the report can be triggered periodically, e.g., via UE-specific RRC signaling.

In another embodiment, the report can be semi-persistent or aperiodic. For example, the report can be triggered by the DCI, where a new field (e.g., 1-bit triggering field) can be introduced to the DCI for the report triggering. In one example, an IE similar to IE CSI-ReportConfig can be introduced for the report configuration of UE assistance information to support ML/AI techniques. In yet another embodiment, the report can be triggered via certain event. For example, the UE can report the model parameter updates before it enters RRC inactive and/or idle mode. Whether UE should report the model parameter updates can additionally depend on the configuration, e.g., configuration via RRC signaling regarding whether the UE needs to report the model parameter updates.

TABLE 4 provides an example of the IE for the configuration of UE assistance information report, where whether the report is periodic or semi-persistent or aperiodic, the resources for the report transmission, and/or report contents can be included. The ‘parameter1’ to ‘parameterN’ and the possible values ‘X1’ to ‘XN’ and ‘Y1 to YN’ are listed as examples, while other possible methods for the configuration of model parameters are not excluded. Also, for the ‘UE-location’, if (as an example) a set of UE locations are predefined, and the UE can report one of the predefined location via the index L2, L2, etc. However, other methods for report of UE location are not excluded.

TABLE 4
Example of IE for configuration of UE assistance information
report for support of ML/AI techniques

| | |
|---|---|
| MlReport-ReportConfig ::= | SEQUENCE { |
| reportConfigId | MlReport-ReportConfigId, |
| reportConfigType | CHOICE { |
| periodic | SEQUENCE { |

| | |
|---|---|
| reportSlotConfig | MlReport- |
| ReportPeriodicityAndOffset, | |
| pucch-MlReport-ResourceList | SEQUENCE (SIZE |

```
          (1..maxNrofBWPs)) OF PUCCH-MlReport-Resource
      },
```

| | |
|---|---|
| semiPersistentOnPUCCH | SEQUENCE { |

| | |
|---|---|
| reportSlotConfig | MlReport- |

ReportPeriodicityAndOffset,

| | |
|---|---|
| pucch-MlReport-ResourceList | SEQUENCE (SIZE |

```
          (1..maxNrofBWPs)) OF PUCCH-MlReport-Resource
      },
```

| | |
|---|---|
| semiPersistentOnPUSCH | SEQUENCE { |

| | |
|---|---|
| reportSlotConfig | ENUMERATED {sl5, |

sl10, sl20, sl40, sl80, sl160, sl320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH-AlphaSetId |

},

| | |
|---|---|
| aperiodic | SEQUENCE { |

| | |
|---|---|
| reportSlotOffsetList | SEQUENCE (SIZE |

```
          (1..maxNrofUL-Allocations)) OF INTEGER(0..32)
      }
  },
```

| | |
|---|---|
| reportQuantity | CHOICE { |
| none | NULL, |
| model-parameters | SEQUENCE { |

| | |
|---|---|
| parameter1 | INTEGER (−X1..Y1) |
| parameter2 | INTEGER (−X2..Y2) |

...

| | |
|---|---|
| parameterN | INTEGER (−XN..YN) |

}

| | |
|---|---|
| UE-location | ENUMERATED {L1, L2, ...} |

...
},
MlReport-ReportPeriodicityAndOffset ::= CHOICE {

| | |
|---|---|
| slots4 | INTEGER(0..3), |
| slots5 | INTEGER(0..4), |
| slots8 | INTEGER(0..7), |
| slots10 | INTEGER(0.. 9) , |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-mlReport-Resource ::= | SEQUENCE { |
| uplinkBandwidthPartId | BWP-Id, |
| pucch-Resource | PUCCH-ResourceId |

}
...
}

Although this disclosure has been described with an exemplary embodiment, various changes and modifications may be suggested to one skilled in the art. It is intended that this disclosure encompass such changes and modifications as fall within the scope of the appended claims.

What is claimed is:

1. A user equipment (UE), comprising:
a transceiver configured to receive, from a base station, machine learning/artificial intelligence (ML/AI) configuration information including one or more of enabling/disabling an ML approach for one or more operations, one or more ML models to be used for the one or more operations, trained model parameters for the one or more ML models, or whether ML model parameters received from the UE at the base station will be used; and
a processor operatively coupled to the transceiver, the processor configured to generate assistance information for updating the one or more ML models based on at least a portion of the configuration information,
wherein the transceiver is further configured to transmit the assistance information to the base station.

2. The UE of claim 1, wherein one of
the processor is further configured to perform an inference regarding the one or more operations based on the configuration information and local data, or
the transceiver is configured to receive, from the base station, control signaling based on an inference result, the control signaling including one of a command based on the inference result and updated configuration information.

3. The UE of claim 1, wherein
the assistance information comprises at least one of
local data regarding the UE, including one or more of UE location, UE trajectory, or estimated downlink (DL) channel status,
inference results regarding the one or more operations, or
updated model parameters based on local training of the one or more ML models, for updating the one or more ML models,
the assistance information is reported using L1/L2 including one of an uplink control information (UCI), a medium access control (MAC) control element (MAC-CE), a physical uplink control channel (PUCCH), a physical uplink shared channel (PUSCH), or a physical random access channel (PRACH), and
reporting of the assistance information is triggered periodically, aperiodically, or semi-persistently.

4. The UE of claim 1, wherein the configuration information specifies a federated learning ML model to be used for the one or more operations, the federated learning ML model involving model training at the UE based on local data available at UE and reporting of updated model parameters according to the configuration information.

5. The UE of claim 1, wherein the transceiver is configured to transmit, to the base station, UE capability information for use by the base station in generating the configuration information, the UE capability information including one or more of support by the UE for the ML approach for the one or more operations, and support by the UE for model training at the UE based on local data available at UE.

6. The UE of claim 1, wherein the configuration information includes one or more of
N indices each corresponding to a different one of the one or more operations and indicating enabling or disabling of the ML approach for the corresponding operation,
M indices each corresponding to a different one of M predefined ML algorithms and indicating an ML algorithm to be employed for the corresponding operation(s), or
K indices each corresponding to a different one of K predefined ML operation modes and indicating an ML operation mode to be employed, each of the ML operation modes including one or more operations, an ML algorithm to be employed for a corresponding one of the one or more operations, and ML model parameters for the ML algorithm to be employed for the corresponding one of the one or more operations.

7. The UE of claim 6, wherein one of
the ML algorithm comprises supervised learning and the ML model parameters comprise features, weights, and regularization,
the ML algorithm comprises reinforcement learning and the ML model parameters comprise a set of states, a set of actions, a state transition probability, or a reward function,
the ML algorithm comprises a deep neural network and the ML model parameters comprise a number of layers, a number of neurons in each layer, weights and bias for each neuron, an activation function, inputs, or outputs,
the ML algorithm comprises federated learning and the ML model parameters comprise whether the UE is configured for local training and/or reporting, a number of iterations for local training before polling, and local batch size.

8. A method, comprising:
receiving, at a user equipment (UE) from a base station, machine learning/artificial intelligence (ML/AI) configuration information including one or more of enabling/disabling an ML approach for one or more operations, one or more ML models to be used for the one or more operations, trained model parameters for the one or more ML models, or whether ML model parameters received from the UE at the base station will be used;
generating assistance information for updating the one or more ML models based on the configuration information; and
transmitting, from the UE to the base station, the assistance information.

9. The method of claim 8, wherein the method further comprises one of
performing an inference regarding the one or more operations based on the configuration information and local data, or
receiving, from the base station, control signaling based on an inference result, the control signaling including one of a command based on the inference result and updated configuration information.

10. The method of claim 8, wherein
the assistance information comprises at least one of
local data regarding the UE, including one or more of UE location, UE trajectory, or estimated downlink (DL) channel status,
inference results regarding the one or more operations, or
updated model parameters based on local training of the one or more ML models, for updating the one or more ML models,
the assistance information is reported using L1/L2 including one of an uplink control information (UCI), a medium access control (MAC) control element (MAC-CE), a physical uplink control channel (PUCCH), a physical uplink shared channel (PUSCH), or a physical random access channel (PRACH), or, and
reporting of the assistance information is triggered periodically, aperiodically, or semi-persistently.

11. The method of claim 8, wherein the configuration information specifies a federated learning ML model to be used for the one or more operations, the federated learning ML model involving model training at the UE based on local data available at UE and reporting of updated model parameters according to the configuration information.

12. The method of claim 8, further comprising transmitting, from the UE to the base station, UE capability information for use by the base station in generating the configuration information, the UE capability information including one or more of support by the UE for the ML approach for the one or more operations, and support by the UE for model training at the UE based on local data available at UE.

13. The method of claim 8, wherein the configuration information includes one or more of
N indices each corresponding to a different one of the one or more operations and indicating enabling or disabling of the ML approach for the corresponding operation,
M indices each corresponding to a different one of M predefined ML algorithms and indicating an ML algorithm to be employed for the corresponding operation(s), or
K indices each corresponding to a different one of K predefined ML operation modes and indicating an ML operation mode to be employed, each of the ML operation modes including one or more operations, an ML algorithm to be employed for a corresponding one of the one or more operations, and ML model parameters for the ML algorithm to be employed for the corresponding one of the one or more operations.

14. The method of claim 13, wherein one of
the ML algorithm comprises supervised learning and the ML model parameters comprise features, weights, and regularization,
the ML algorithm comprises reinforcement learning and the ML model parameters comprise a set of states, a set of actions, a state transition probability, or a reward function,
the ML algorithm comprises a deep neural network and the ML model parameters comprise a number of layers, a number of neurons in each layer, weights and bias for each neuron, an activation function, inputs, or outputs,
the ML algorithm comprises federated learning and the ML model parameters comprise whether the UE is configured for local training and/or reporting, a number of iterations for local training before polling, and local batch size.

15. A base station (BS), comprising:
a processor configured to generate machine learning/artificial intelligence (ML/AI) configuration information including one or more of enabling/disabling an ML approach for one or more operations, one or more ML models to be used for the one or more operations, trained model parameters for the one or more ML models, or whether ML model parameters received from a user equipment (UE) at the base station will be used; and
a transceiver operatively coupled to the processor and configured to
transmit, to one or more UEs including the UE, the configuration information, and
receive, from the UE, assistance information for updating the one or more ML models.

16. The BS of claim 15, wherein one of
the transceiver is further configured to receive, from the UE, an inference regarding the one or more operations based on the configuration information and local data at the UE,
the processor is further configured to perform an inference regarding the one or more operations based on assistance information received from the one or more UEs including the UE, or
the transceiver is further configured to receive an inference regarding the one or more operations based on the assistance information received from the one or more UEs from another network entity.

17. The BS of claim 15, wherein
the assistance information comprises at least one of
local data at the UE regarding the UE, including one or more of UE location, UE trajectory, or estimated downlink (DL) channel status,
inference results regarding the one or more operations, or
updated model parameters based on local training of the one or more ML models, for updating the one or more ML models,
the assistance information is reported using L1/L2 including one of an uplink control information (UCI), a medium access control (MAC) control element (MAC-CE), a physical uplink control channel (PUCCH), a physical uplink shared channel (PUSCH), or a physical random access channel (PRACH), and
reporting of the assistance information is triggered periodically, aperiodically, or semi-persistently.

18. The BS of claim 15, wherein the configuration information specifies a federated learning ML model to be used for the one or more operations, the federated learning ML model involving model training at the UE based on local data available at UE and reporting of updated model parameters according to the configuration information.

19. The BS of claim 15, wherein the transceiver is configured to receive, from at least the UE, UE capability information for use by the base station in generating the configuration information, the UE capability information including one or more of support by the UE for the ML approach for the one or more operations, and support by the UE for model training at the UE based on local data available at UE.

20. The BS of claim 15, wherein the configuration information includes one or more of
N indices each corresponding to a different one of the one or more operations and indicating enabling or disabling of the ML approach for the corresponding operation,
M indices each corresponding to a different one of M predefined ML algorithms and indicating an ML algorithm to be employed for the corresponding operation(s), or
K indices each corresponding to a different one of K predefined ML operation modes and indicating an ML operation mode to be employed, each of the ML operation modes including one or more operations, an ML algorithm to be employed for a corresponding one of the one or more operations, and ML model parameters for the ML algorithm to be employed for the corresponding one of the one or more operations, and
wherein one of
the ML algorithm comprises supervised learning and the ML model parameters comprise features, weights, and regularization,
the ML algorithm comprises reinforcement learning and the ML model parameters comprise a set of states, a set of actions, a state transition probability, or a reward function,
the ML algorithm comprises a deep neural network and the ML model parameters comprise a number of layers, a number of neurons in each layer, weights and bias for each neuron, an activation function, inputs, or outputs,
the ML algorithm comprises federated learning and the ML model parameters comprise whether the UE is configured for local training and/or reporting, a number of iterations for local training before polling, and local batch size.
